(19) United States
(12) Patent Application Publication
(10) Pub. No.: US 2019/0113906 A1
(43) Pub. Date: Apr. 18, 2019

(54) NUMERICAL CONTROL APPARATUS AND TOOLPATH DETERMINATION METHOD

(71) Applicant: Fanuc Corporation, Yamanashi (JP)

(72) Inventor: Yuuji DEGUCHI, Yamanashi-ken (JP)

(21) Appl. No.: 16/158,757

(22) Filed: Oct. 12, 2018

(30) Foreign Application Priority Data
Oct. 18, 2017 (JP) 2017-202033

(51) Int. Cl. G05B 19/4061; G05B 19/4093; G05B 19/402

(52) U.S. Cl. CPC G05B 19/4061; G05B 19/402; G05B 19/40937

(57) ABSTRACT

A numerical control apparatus acquires a before-machining workpiece shape and an after-machining part shape from a cycle command analyzer that analyzes a machining cycle command and from the analysis result. Then, based on the workpiece shape and the part shape, a machining field is determined, and a toolpath of the tool of the machine tool is generated based on the machining field. Based on the shape and the position of the predetermined obstacle and the toolpath, it is determined whether the obstacle is expected to interfere with the tool. When the obstacle is determined to interfere with the tool, the toolpath is modified so that the obstacle will not interfere with the tool.

### CROSS-REFERENCE TO RELATED APPLICATION

This application is based upon and claims the benefit of priority from Japanese Patent Application No. 2017-202033 filed on Oct. 18, 2017, the contents of which are incorporated herein by reference.

### BACKGROUND OF THE INVENTION

### Field of the Invention

The present invention relates to a numerical control apparatus and a toolpath determination method for generating a toolpath along which a tool moves based on a machining cycle command.

### Description of the Related Art

Japanese Laid-Open Patent Publication No. 2016-139349 discloses a numerical control apparatus capable of modifying part of a toolpath.

### SUMMARY OF THE INVENTION

However, in the configuration disclosed in Japanese Laid-Open Patent Publication No. 2016-139349, when there is an obstacle in the toolpath, the operator has to select the portion to be corrected and correct the toolpath, which is troublesome.

It is therefore an object of the present invention to provide a numerical control apparatus and a toolpath determination method that can easily generate a toolpath for avoiding obstacles.

According to a first aspect of the present invention, a numerical control apparatus includes: a cycle command analyzer configured to analyze a machining cycle command included in a machining program; a workpiece shape obtainer configured to obtain a before-machining workpiece shape from an analysis result of the cycle command analyzer; a part shape obtainer configured to obtain an after-machining part shape from the analysis result of the cycle command analyzer; a machining field determiner configured to determine a machining field based on the workpiece shape and the part shape; a path generator configured to generate a toolpath of a tool of a machine tool based on the machining field; an obstacle information obtainer configured to obtain a shape and a position of a predetermined obstacle; an interference determiner configured to determine whether the obstacle will interfere with the tool based on the toolpath and the shape and the position of the obstacle; and a path modifier configured to modify the toolpath so as not to cause interference between the tool and the obstacle when it is determined that the obstacle will interfere with the tool.

According to a second aspect of the present invention, a toolpath determination method includes: a cycle command analyzing step of analyzing a machining cycle command included in a machining program; a workpiece shape obtaining step of obtaining a before-machining workpiece shape from an analysis result of the machining cycle command; a part shape obtaining step of obtaining an after-machining part shape from the analysis result of the machining cycle command; a machining field determining step of determining a machining field based on the workpiece shape and the part shape; a path generating step of generating a toolpath of a tool of a machine tool based on the machining field; an obstacle information obtaining step of obtaining a shape and a position of a predetermined obstacle; an interference determining step of determining whether the obstacle will interfere with the tool based on the toolpath and the shape and the position of the obstacle; and a path modifying step of modifying the toolpath so as not to cause interference between the tool and the obstacle when it is determined that the obstacle will interfere with the tool.

According to the present invention, when the obstacle is expected to interfere with the tool, the toolpath is automatically corrected so that a toolpath that will not cause any interference between the tool and the obstacle can be easily obtained. Therefore, it is possible to prevent the obstacle from interfering with the tool.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a functional block diagram showing a configuration of a numerical control apparatus for numerically controlling a machine tool;

FIG. 2 is a diagram showing an example of the shape of a workpiece;

FIG. 3 is a diagram showing an example of the shape of a part obtained by machining a workpiece;

FIG. 4 is a diagram showing an example of a machining field determined by a machining field determiner shown in FIG. 1;

FIG. 5 is a diagram showing an example of a toolpath generated by a path generator shown in FIG. 1;

FIG. 6 is a diagram showing an example of an obstacle located between a tool and a workpiece;

FIG. 7 is a diagram showing an example of a toolpath corrected by a path modifier shown in FIG. 1;

FIG. 8 is a diagram showing an example of a toolpath corrected by a path modifier shown in FIG. 1;

FIG. 9 is a flowchart showing the operation of a numerical control apparatus shown in FIG. 1; and

FIG. 10 is a flowchart showing the operation of modifying a toolpath during generation of a toolpath.

### DESCRIPTION OF THE PREFERRED EMBODIMENTS

### Embodiment

A numerical control apparatus and a toolpath determination method according to the present invention will be detailed hereinbelow by describing a preferred embodiment with reference to the accompanying drawings.

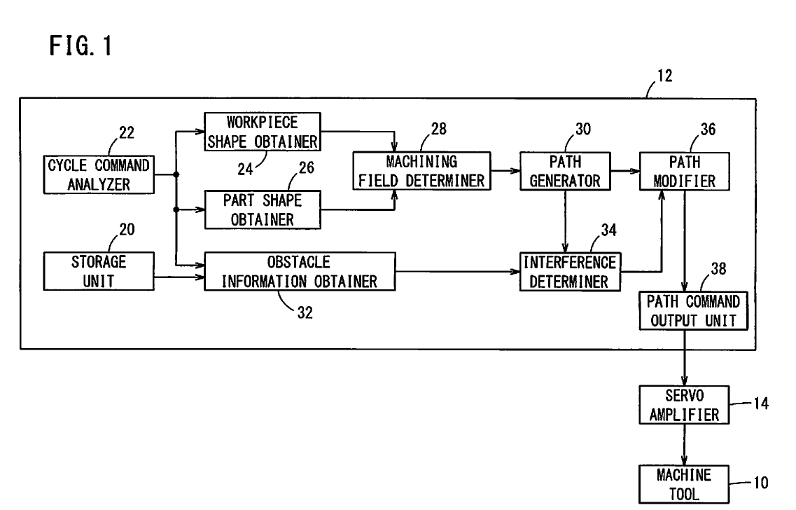

FIG. 1 is a functional block diagram showing a configuration of a numerical control apparatus 12 for numerically controlling a machine tool 10. Although not shown, the numerical control apparatus 12 includes an operation unit such as a keyboard and the like that accepts operator's instructions, a display unit such as a liquid crystal display, an organic EL display, and the like that displays images, and a control unit that includes memory and a processor such as a CPU. The numerical control apparatus 12 moves a tool TO relative to a workpiece W via a servo amplifier 14 in order to machine the workpiece (an object to be machined) W with the tool TO of the machine tool 10. The servo amplifier 14 drives servomotors for relatively moving the tool TO relative to the workpiece W. Here, the tool TO moves relative to the workpiece W in the X-axis direction, the Y-axis direction, and the Z-axis direction.

The numerical control apparatus 12 includes a storage unit 20, a cycle command analyzer 22, a workpiece shape obtainer 24, a part shape obtainer 26, a machining field determiner 28, a path generator 30, an obstacle information obtainer 32, an interference determiner 34, a path modifier 36, and a path command output unit 38.

The storage unit 20 stores a machining program that enables the tool TO of the machine tool 10 to machine a workpiece (object to be machined) W. Machining conditions and machining parameters used for machining are also stored. The storage unit 20 may also store the shape and the position of obstacles IO that are set within the machining field of the machine tool 10 and that could interfere with the tool TO when the workpiece W is machined. The obstacle IO does not include the workpiece W.

The cycle command analyzer 22 reads the machining program from the storage unit 20 and analyzes machining cycle command included in the machining program. The analysis result of the cycle command analyzer 22 is output to the workpiece shape obtainer 24 and the part shape obtainer 26.

A machining cycle command may be written in, for example, G-codes. The machining cycle command may include (G-code) commands indicating information on the shape (inclusive of the size) of the workpiece W before machining, and (G-code) commands indicating information on the shape (inclusive of the size) of a part MW that is obtained after the workpiece W is machined. Further, the machining cycle command may include G-codes indicating information on the shape (inclusive of the size) and the position of the obstacle IO.

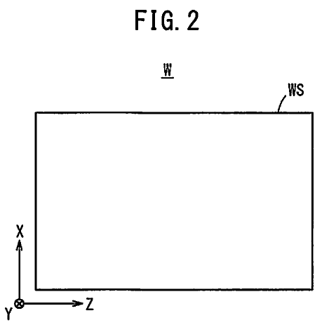

The workpiece shape obtainer 24 acquires from the analysis result of the machining cycle command, the shape of the workpiece W before machining (referred hereinbelow as workpiece shape WS). The workpiece shape obtainer 24 outputs the acquired workpiece shape WS to the machining field determiner 28. FIG. 2 is a diagram showing an example of the workpiece shape WS obtained by the workpiece shape obtainer 24.

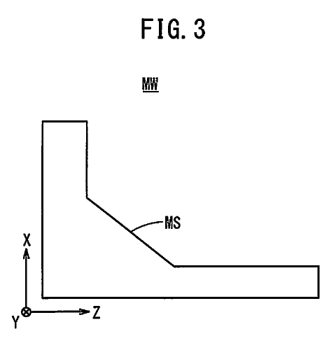

The part shape obtainer 26 acquires, from the analysis result of the machining cycle command, the shape of the part MW after machining (referred hereinbelow as part shape MS). The part shape obtainer 26 outputs the acquired part shape MS to the machining field determiner 28. FIG. 3 is a diagram showing an example of the part shape MS obtained by the part shape obtainer 26.

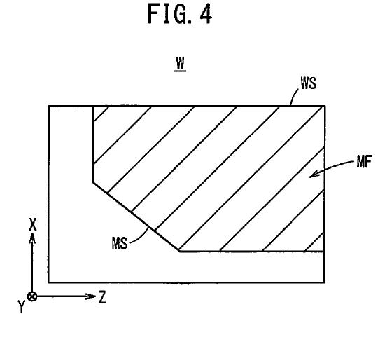

The machining field determiner 28 determines the machining field MF of the workpiece W from the workpiece shape WS and the part shape MS. The machining field MF is an area left when the part shape MS is subtracted from the workpiece shape WS. For example, when the workpiece shape WS and the part shape MS have shapes of those shown in FIGS. 2 and 3 respectively, the machining field MF determined by the machining field determiner 28 becomes the hatched area shown in FIG. 4. The machining field determiner 28 outputs the determined machining field MF to the path generator 30.

The path generator 30 generates a toolpath PA of the tool TO of the machine tool 10 based on the machining field MF. The toolpath PA is a path along which the tool TO moves relative to the workpiece W in the machining cycle. The path generator 30 outputs the generated toolpath PA to the interference determiner 34 and the path modifier 36.

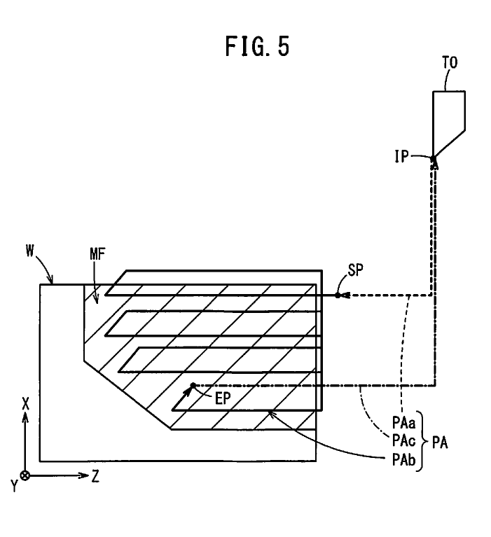

The path generator 30 generates a toolpath PA (approach path PAa, machining path PAb, and withdrawal path PAc) according to predetermined rules. The path generator 30 generates the toolpath PA as shown in FIG. 5, for example. It is assumed in the description of the present embodiment that the axial direction of the tool TO extends in the X-axis direction of the machine tool 10 (parallel to the X-axis direction in the present embodiment), crossing the Y-axis direction and the Z-axis direction of the machine tool 10 (orthogonal to each of them in the present embodiment).

The toolpath PA includes the approach path PAa (shown by the broken line) for moving the tool TO from an initial position IP of the tool TO before the tool TO moves, to a machining start position SP of the workpiece W; the machining path PAb (shown by the solid line) for moving the tool TO to actually machine the workpiece W; and the withdrawal path PAc (shown by the dashed line) for moving the tool TO from a machining end position EP of the workpiece W to the initial position IP after the machining is completed. The approach path PAa and the withdrawal path PAc are traveling paths of the tool TO outside the machining field MF and the machining path PAb is a traveling path of the tool TO inside the machining field MF. The machining path PAb is the path along which the tool TO moves from the machining start position SP to the machining end position EP.

The obstacle information obtainer 32 acquires the shape (inclusive of the size) and the position of the obstacle IO that may interfere with the tool TO. The obstacle information obtainer 32 outputs the obtained shape and position of the obstacle IO to the interference determiner 34.

The obstacle information obtainer 32 may acquire the shape and the position of the obstacle IO from the storage unit 20. In this case, it is based on the premise that the obstacle data indicating the shape and the position of the obstacle IO are stored in the storage unit 20. Thereby, the machining cycle command does not need to include the information on the obstacle IO, whereby the machining cycle command can be simplified.

Further, the obstacle information obtainer 32 may acquire the shape and the position of the obstacle IO from the analysis result of the machining cycle command. In this case, it is based on the premise that information on the shape and the position of the obstacle IO are written in the machining cycle command. This eliminates the need to separately store the obstacle data in the storage unit 20, and makes it possible to save time and labor for storing the obstacle data.

Based on the toolpath PA and the shape and the position of the obstacle IO, the interference determiner 34 determines whether or not the obstacle IO will interfere with the tool TO when the tool TO is moved along the toolpath PA. Since the obstacle IO will never interfere with the tool TO in the machining path PAb, the interference determiner 34 determines whether or not the obstacle IO will interfere with the tool TO on the approach path PAa and the withdrawal path PAc. The interference determiner 34 outputs the determination result to the path modifier 36.

When the interference determiner 34 determines that the obstacle IO will interfere with the tool TO, the path modifier 36 corrects the toolpath PA so that the obstacle IO will not interfere with the tool TO. Since, in the machining path PAb, the obstacle IO will not interfere with the tool TO, when interference between the tool TO and the obstacle 10 is expected, the path modifier 36 corrects the approach path PAa or the withdrawal path PAc or both along which the obstacle IO is expected to interfere with the tool TO.

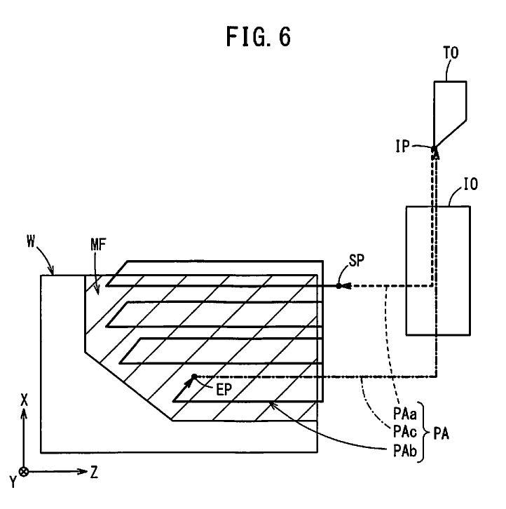

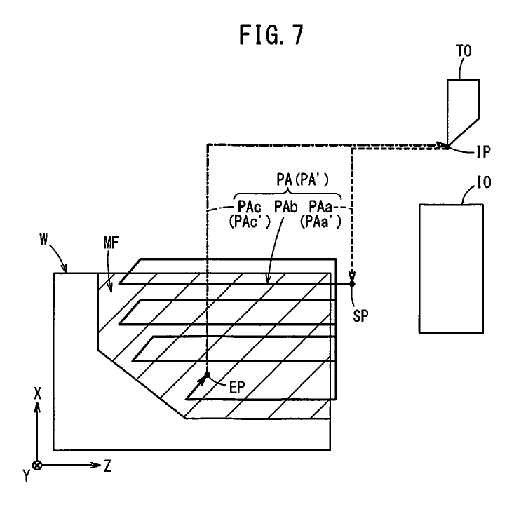

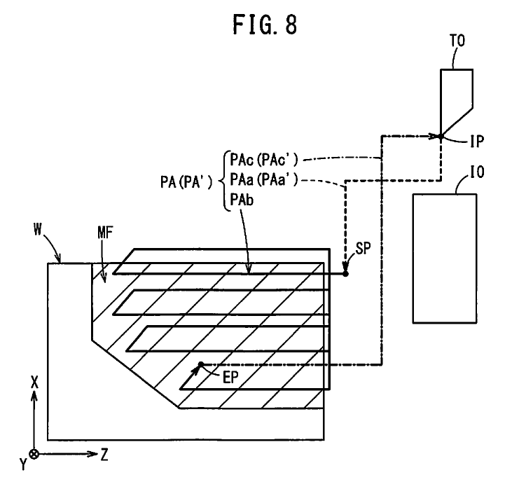

For example, when there is an obstacle IO as shown in FIG. 6, the interference determiner 34 determines that the obstacle IO will interfere with the tool TO on the approach path PAa and the withdrawal path PAc. Therefore, the path modifier 36 modifies the approach path PAa and the withdrawal path PAc into those as shown in FIG. 7. Alternatively, in the case where there is an obstacle IO as shown in FIG. 6, the path modifier 36 may modify the approach path PAa and the withdrawal path PAc into those as shown in FIG. 8.

In a case where there is interference between the tool TO and the obstacle IO on the approach path PAa, the path modifier 36 may modify the approach path PAa in such a manner as to make the tool TO move away from the obstacle IO in the Y-axis direction and the Z-axial direction while the tool TO moves along the tool TO's axial direction (X-axis direction) from the initial position IP to the obstacle IO. When it is determined that there is interference between the tool TO and the obstacle IO on the withdrawal path PAc, the path modifier 36 may modify the withdrawal path PAc in such a manner as to keep the tool TO away from the obstacle IO in the X-axis direction while the tool TO moves in the Y-axis direction and the Z-axis direction from the machining end position EP to the obstacle IO. Thereby, it is possible to modify the approach path PAa and the withdrawal path PAc simply and reliably so as not to cause interference between the tool TO and the obstacle IO.

In order to distinguish between the before-modification approach path PAa and the after-modification approach path PAa, the modified approach path PAa may be denoted as PAa′. Likewise, in order to distinguish between the before-modification withdrawal path PAc and the after-modification withdrawal path PAc, the modified withdrawal path PAc may be represented by PAc′. Also, in order to distinguish between the toolpath PA which has not been modified and the toolpath PA which has been modified, the modified toolpath PA may be represented by PA′. This toolpath PA′ is obtained by modifying at least one of the approach path PAa and the withdrawal path PAc of the toolpath PA.

When it is determined by the interference determiner 34 that the obstacle IO will not interfere with the tool TO, the path modifier 36 outputs the toolpath PA to the path command output unit 38. When it is determined that the obstacle IO will interfere with the tool TO, the path modifier 36 outputs the toolpath PA′ to the path command output unit 38.

The path command output unit 38 outputs a command signal to the servo amplifier 14 so that the tool TO moves along the received toolpath PA or PA′.

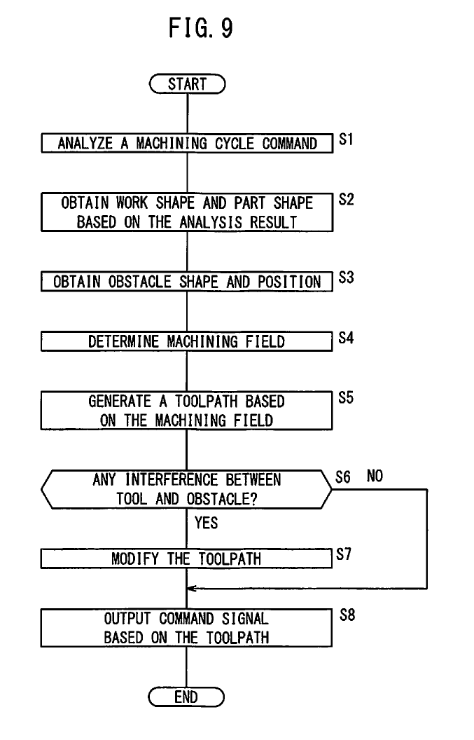

The operation of the numerical control apparatus 12 will be described with reference to FIG. 9. At step S1, the cycle command analyzer 22 reads out the machining program from the storage unit 20 and analyzes the machining cycle command included in the machining program.

Next, at step S2 the workpiece shape obtainer 24 and the part shape obtainer 26 acquire the before-machining workpiece shape WS and the part shape MS, based on the analysis result obtained at step S1.

Next, at step S3 the obstacle information obtainer 32 acquires the shape and the position of the predetermined obstacle IO. The obstacle information obtainer 32 may acquire the shape and the position of the obstacle IO from the storage unit 20 or may acquire the shape and the position of the obstacle IO based on the analysis result of step S1.

Next, at step S4 the machining field MF is determined from the workpiece shape WS and the part shape MS obtained at step S2.

Next, at step S5 the path generator 30 generates a toolpath PA based on the machining field MF determined at step S4.

Next, at step S6, based on the shape and the position of the obstacle IO obtained at step S3 and the toolpath PA generated at step S5, the interference determiner 34 determines whether or not the obstacle IO will interfere with the tool TO as the tool TO moves along the toolpath PA. When it is determined at step S6 that interference will occur, the control goes to step S7, and when it is determined that no interference will occur, the control proceeds to step S8.

At step S7, the path modifier 36 modifies the toolpath PA and the control proceeds to step S8. The path modifier 36 modifies part of the approach path PAa and the withdrawal path PAc where the obstacle IO will interfere with the tool TO.

Next, at step S8, a command signal is generated based on the toolpath PA (or the toolpath PA′ when the toolpath PA is modified) and output to the servo amplifier 14.

In this way, when the tool TO and the obstacle IO are expected to interfere with each other, the toolpath PA is automatically corrected, whereby it is possible to easily obtain the toolpath PA′ which will not cause any interference between the tool TO and the obstacle IO. Thus, it is possible to prevent the tool TO from interfering with the obstacle IO.

### Variational Examples

In the control described with FIG. 9, after the toolpath PA is generated, i.e., after all of the approach path PAa, the machining path PAb, and the withdrawal path PAc are generated, it is determined whether or not the tool TO and the obstacle IO will interfere with each other and if there is interference, the toolpath PA is corrected. As another approach, it is possible to determine whether or not the obstacle IO will interfere with the tool TO during the generation of the toolpath PA and to modify the toolpath PA during the generation of the toolpath PA if interference is expected to occur.

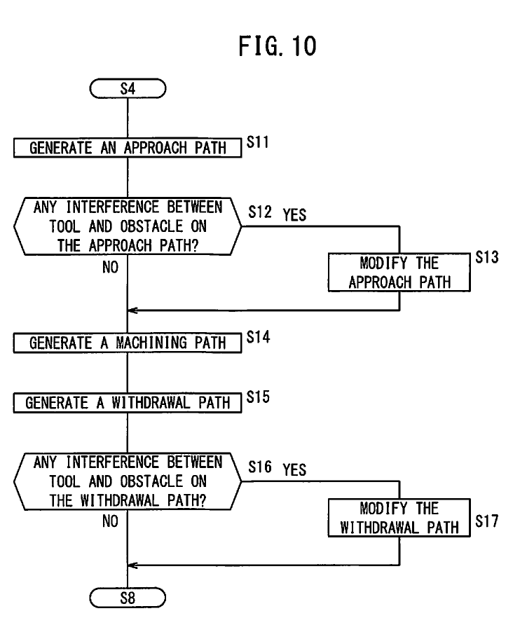

FIG. 10 is a flowchart showing an operation of modifying the toolpath PA during the generation thereof. That is, the control shown in FIG. 10 is executed in place of the control from step S5 to step S7 in FIG. 9.

After step S4 in FIG. 9, the control proceeds to step S11 in FIG. 10, and the path generator 30 generates an approach path PAa.

Then, at step S12 the interference determiner 34 determines whether or not the tool TO and the obstacle IO will interfere with each other on the approach path PAa. That is, based on the shape and the position of the obstacle IO obtained at step S3 of FIG. 9 and the approach path PAa generated at step S11, the interference determiner 34 determines whether or not the obstacle IO will interfere with the tool TO. If it is determined at step S12 that the tool TO and the obstacle IO will interfere with each other, the control proceeds to step S13. If it is determined that the obstacle IO will not interfere with the tool TO, the control goes to step S14.

At step S13, the path modifier 36 modifies the approach path PAa so that the tool TO and the obstacle IO will not interfere on the approach path PAa, and the control goes to step S14.

At step S14, the path generator 30 generates a machining path PAb and then generates a withdrawal path PAc at step S15.

Next, at step S16, the interference determiner 34 determines whether or not the tool TO and the obstacle IO will interfere with each other on the withdrawal path PAc. That is, based on the shape and the position of the obstacle IO obtained at step S3 of FIG. 9 and the withdrawal path PAc generated at step S15, the interference determiner 34 determines whether or not the obstacle IO will interfere with the tool TO. If it is determined at step S16 that the obstacle IO will interfere with the tool TO, the control proceeds to step S17. If it is determined that the obstacle IO will not interfere with the tool TO, the control goes to step S8 in FIG. 9.

At step S17, the path modifier 36 corrects the withdrawal path PAc so as not to cause interference between the tool TO and the obstacle IO on the withdrawal path PAc, and then the control proceeds to step S8 in FIG. 9.

Similarly to the above embodiment, also in the variational example, when the tool TO and the obstacle IO is expected to interfere with each other as in the above embodiment, the toolpath PA is automatically corrected, so that it is possible to easily obtain the toolpath PA′ which will not cause any interference between the tool TO and the obstacle IO. Therefore, it is possible to prevent the tool TO from interfering with the obstacle IO.

### Technical Idea Obtained from the Embodiment

Technical ideas that can be grasped from the above embodiment and modifications are described below.

### First Technical Idea

The numerical control apparatus (12) includes: the cycle command analyzer (22) configured to analyze the machining cycle command included in the machining program; the workpiece shape obtainer (24) configured to obtain the before-machining workpiece shape (WS) from the analysis result of the cycle command analyzer (22); the part shape obtainer (26) configured to obtain the after-machining part shape (MS) from the analysis result of the cycle command analyzer (22); the machining field determiner (28) configured to determine the machining field (MF) based on the workpiece shape (WS) and the part shape (MS); the path generator (30) configured to generate the toolpath (PA) of the tool (TO) of the machine tool (10) based on the machining field (MF); the obstacle information obtainer (32) configured to obtain the shape and the position of the predetermined obstacle (IO); the interference determiner (34) configured to determine whether the obstacle (IO) will interfere with the tool (TO) based on the toolpath (PA) and the shape and the position of the obstacle (IO); and the path modifier (36) configured to modify the toolpath (PA) so as not to cause interference between the tool (TO) and the obstacle (IO) when it is determined that the obstacle (IO) will interfere with the tool (TO).

With this configuration, when the obstacle (IO) is expected to interfere with the tool (TO), the toolpath (PA) is automatically corrected, so that it is possible to easily obtain a toolpath (PA′) which will not cause any interference between the tool (TO) and the obstacle (IO). Accordingly, it is possible to prevent the obstacle (IO) from interfering with the tool (TO).

The numerical control apparatus (12) may further include the storage unit (20) configured to store obstacle data representing the shape and the position of the obstacle (IO). The obstacle information obtainer (32) may be configured to obtain the shape and the position of the obstacle (IO) from the obstacle data stored in the storage unit (20).

Thereby, the machining cycle command does not need to include the information on the obstacle (IO), so that the machining cycle command can be simplified.

The machining cycle command may include information representing the shape and the position of the obstacle (IO). The obstacle information obtainer (32) may be configured to obtain the shape and the position of the obstacle (IO) from the analysis result of the cycle command analyzer (22).

This eliminates the need to separately store the obstacle data in the storage unit (20) and makes it possible to save time and labor for storing the obstacle data.

The tool path may include the approach path (PAa) and the withdrawal path (PAc). The interference determiner (34) may determine whether the tool (TO) and the obstacle (IO) will interfere with each other on an approach path (PAa) along which the tool (TO) moves from an initial position (IP), which is the position of the tool (TO) before the tool starts moving, to the machining start position (SP) and on the withdrawal path (PAc) along which the tool (TO) moves from the machining end position (EP) to the initial position (IP). The path modifier (36) may be configured to modify a path where the obstacle (IO) will interfere with the tool (TO) among the approach path (PAa) and the withdrawal path (PAc).

As a result, it is possible to easily obtain a toolpath (PA′) on which the tool (TO) and the obstacle (IO) will not interfere. Therefore, it is possible to prevent the obstacle (IO) from interfering with the tool (TO).

The tool (TO) may be movable relative to the workpiece (W), in the axial direction of the tool (TO) and in a direction crossing the axial direction. In a case where the interference determiner (34) determines that there is interference between the tool (TO) and the obstacle (IO) on the approach path (PAa), the path modifier (36) may modify the approach path (PAa) in such a manner as to make the tool (TO) move away from the obstacle (IO) in the crossing direction while the tool (TO) moves from the initial position (IP) to the obstacle (IO) along the tool (TO)'s axial direction. When the interference determiner (34) determines that there is interference between the tool (TO) and the obstacle (TO) on the withdrawal path (PAc), the path modifier (36) may modify the withdrawal path (PAc) in such a manner as to keep the tool (TO) away from the obstacle (IO) in the axial direction while the tool (TO) moves from the machining end position (EP) to the obstacle (IO) in the crossing direction.

Thereby, the approach path (PAa) and the withdrawal route (PAc) can be corrected easily and reliably so that the tool (TO) and the obstacle (IO) will not interfere. Therefore, it is possible to prevent the obstacle (IO) from interfering with the tool (TO).

### Second Technical Idea

The toolpath determination method includes: the cycle command analyzing step of analyzing the machining cycle command included in the machining program; the workpiece shape obtaining step of obtaining the before-machining workpiece shape (WS) from the analysis result of the machining cycle command; the part shape obtaining step of obtaining the after-machining part shape (MS) from the analysis result of the machining cycle command; the machining field determining step of determining the machining field (MF) based on the workpiece shape (WS) and the part shape (MS); the path generating step of generating the toolpath (PA) of the tool (TO) of the machine tool (10) based on the machining field (MF); the obstacle information obtaining step of obtaining the shape and the position of the predetermined obstacle (IO); the interference determining step of determining whether the obstacle (IO) will interfere with the tool (TO) based on the toolpath (PA) and the shape and the position of the obstacle (IO); and the path modifying step of modifying the toolpath so as not to cause interference between the tool (TO) and the obstacle (IO) when it is determined that the obstacle (IO) will interfere with the tool (TO).

With this configuration, when the obstacle (IO) is expected to interfere with the tool (TO), the toolpath (PA) is automatically corrected, so that it is possible to easily obtain a toolpath (PA′) which will not cause any interference between the tool (TO) and the obstacle (IO). Accordingly, it is possible to prevent the obstacle (IO) from interfering with the tool (TO).

The obstacle information obtaining step may obtain the shape and the position of the obstacle (IO) from the obstacle data representing the shape and the position of the obstacle (IO) stored in the storage unit (20).

Thereby, the machining cycle command does not need to include the information on the obstacle (IO), whereby the machining cycle command can be simplified.

The machining cycle command may include information representing the shape and position of the obstacle (IO). The obstacle information obtaining step may obtain the shape and the position of the obstacle (IO) from the analysis result of the machining cycle command.

This eliminates the need to separately store the obstacle data in the storage unit (20) and makes it possible to save time and labor for storing the obstacle data.

The tool path includes the approach path (PAa) and the withdrawal path (PAc). The interference determining step may determine whether the obstacle (IO) will interfere with the tool (TO) on the approach path (PAa) along which the tool (TO) moves from the initial position (IP), which is a position of the tool before the tool starts moving, to the machining start position (SP) and on the withdrawal path (PAc) along which the tool (TO) moves from the machining end position (EP) to the initial position (IP). The path modifying step may modify a path where the obstacle (IO) will interfere with the tool (TO), among the approach path (PAa) and the withdrawal path (PAc).

As a result, it is possible to easily obtain a toolpath (PA′) in which the obstacle (IO) will not interfere with the tool (TO). Therefore, it is possible to prevent the obstacle (IO) from interfering with the tool (TO).

The tool (TO) may be movable relative to the workpiece (W), in the axial direction of the tool (TO) and in a direction crossing the axial direction. In a case where the interference determining step determines that there is interference between the tool (TO) and the obstacle (IO) on the approach path (PAa), the path modifying step may modify the approach path (PAa) in such a manner as to make the tool (TO) move away from the obstacle (IO) in the crossing direction while the tool (TO) moves from the initial position (IP) to the obstacle (IO) along the tool (TO)'s axial direction. When the interference determining step determines that there is interference between the tool (TO) and the obstacle (IO) on the withdrawal path (PAc), the path modifying step may modify the withdrawal path (PAc) in such a manner as to keep the tool (TO) away from the obstacle (IO) in the axial direction while the tool (TO) moves from the machining end position (EP) to the obstacle (IO) in the crossing direction.

Thereby, the approach path (PAa) and the withdrawal route (PAc) can be corrected easily and reliably so that the obstacle (IO) will not interfere with the tool (TO). Therefore, it is possible to prevent the obstacle (IO) from interfering with the tool (TO).

The present invention is not limited to the above-described embodiment, and various modifications can be made without departing from the gist of the present invention.

What is claimed is:

1. A numerical control apparatus, comprising:
a cycle command analyzer configured to analyze a machining cycle command included in a machining program;
a workpiece shape obtainer configured to obtain a before-machining workpiece shape from an analysis result of the cycle command analyzer;
a part shape obtainer configured to obtain an after-machining part shape from the analysis result of the cycle command analyzer;
a machining field determiner configured to determine a machining field based on the workpiece shape and the part shape;
a path generator configured to generate a toolpath of a tool of a machine tool based on the machining field;
an obstacle information obtainer configured to obtain a shape and a position of a predetermined obstacle;
an interference determiner configured to determine whether the obstacle will interfere with the tool based on the toolpath and the shape and the position of the obstacle; and
a path modifier configured to modify the toolpath so as not to cause interference between the tool and the obstacle when it is determined that the obstacle will interfere with the tool.

2. The numerical control apparatus according to claim 1, further comprising a storage unit configured to store obstacle data representing the shape and the position of the obstacle, wherein
the obstacle information obtainer is configured to obtain the shape and the position of the obstacle from the obstacle data stored in the storage unit.

3. The numerical control apparatus according to claim 1, wherein:
the machining cycle command includes information representing the shape and the position of the obstacle; and
the obstacle information obtainer is configured to obtain the shape and the position of the obstacle from the analysis result of the cycle command analyzer.

4. The numerical control apparatus according to claim 1, wherein:
the tool path includes an approach path and a withdrawal path, the interference determiner determines whether the obstacle will interfere with the tool on the approach path along which the tool moves from an initial position, which is a position of the tool before the tool starts moving, to a machining start position and on the withdrawal path along which the tool moves from a machining end position to the initial position; and
the path modifier is configured to modify a path where the obstacle will interfere with the tool, among the approach path and the withdrawal path.

5. A toolpath determination method, comprising:
a cycle command analyzing step of analyzing a machining cycle command included in a machining program;
a workpiece shape obtaining step of obtaining a before-machining workpiece shape from an analysis result of the machining cycle command;
a part shape obtaining step of obtaining an after-machining part shape from the analysis result of the machining cycle command;
a machining field determining step of determining a machining field based on the workpiece shape and the part shape;
a path generating step of generating a toolpath of a tool of a machine tool based on the machining field;
an obstacle information obtaining step of obtaining a shape and a position of a predetermined obstacle;
an interference determining step of determining whether the obstacle will interfere with the tool based on the toolpath and the shape and the position of the obstacle; and
a path modifying step of modifying the toolpath so as not to cause interference between the tool and the obstacle when it is determined that the obstacle will interfere with the tool.

6. The toolpath determination method according to claim 5, wherein the obstacle information obtaining step obtains the shape and the position of the obstacle from the obstacle data representing the shape and the position of the obstacle stored in a storage unit.

7. The toolpath determination method according to claim 5, wherein:
the machining cycle command includes information representing the shape and the position of the obstacle; and
the obstacle information obtaining step obtains the shape and the position of the obstacle from the analysis result of the machining cycle command.

8. The toolpath determination method according to claim 5, wherein:
the tool path includes an approach path and a withdrawal path, the interference determining step determines whether the obstacle will interfere with the tool on the approach path along which the tool moves from an initial position, which is a position of the tool before the tool starts moving, to a machining start position and on the withdrawal path along which the tool moves from a machining end position to the initial position; and
the path modifying step modifies a path where the obstacle will interfere with the tool, among the approach path and the withdrawal path.
